(19) United States
(12) Patent Application Publication
(10) Pub. No.: US 2014/0074421 A1
(43) Pub. Date: Mar. 13, 2014

(54) METHODS AND SYSTEMS FOR CLOUD COMPUTING TO MITIGATE INSTRUMENT VARIABILITY IN A TEST ENVIRONMENT

(71) Applicant: Apple Inc., Cupertino, CA (US)

(72) Inventors: Ye YIN, Sunnyvale, CA (US); Anuj BHATNAGAR, San Jose, CA (US); Lowell BOONE, Saratoga, CA (US)

(73) Assignee: Apple Inc., Cupertino, CA (US)

(21) Appl. No.: 13/901,502

(22) Filed: May 23, 2013

Related U.S. Application Data
(60) Provisional application No. 61/698,542, filed on Sep. 7, 2012.

(51) Int. Cl. G01D 18/00

(52) U.S. Cl. CPC G01D 18/004
USPC 702/104

(57) ABSTRACT

A system and a method for cloud computing to mitigate instrument variability in a test environment are provided. The system including a test station configured to receive and test a device under test (DUT); a station server configured to provide a data correction algorithm to the memory circuit in the test station; and a data collection server configured to receive test data associated to the DUT in the test station. The data collection server may be further configured to provide a data correction algorithm for the test station to the station server.

### CROSS-REFERENCE TO RELATED APPLICATIONS

The present disclosure claims the benefit under 35 U.S.C. 119(e) of U.S. Provisional Pat. Appl. No. 61/698,542, entitled “STATION CLOUD COMPUTING IN THE LARGE SCALE TESTING ENVIRONMENT TO MITIGATE THE INTRA-INSTRUMENT DIFFERENCES CAUSED MEASUREMENT ACCURACY LOSS,” by Ye Yin et al., filed on Sep. 7, 2012, the contents of which are hereby incorporated by reference in their entirety, for all purposes.

### FIELD OF THE DESCRIBED EMBODIMENTS

The described embodiments relate generally to methods, devices, and systems for use in a test environment to mitigate inter-instrument variability. More particularly, methods and systems disclosed herein relate to cloud computing in a large scale test environment to mitigate accuracy loss due to inter-instrument variability.

### BACKGROUND

In the field of electronic device manufacturing, multiple test platforms are commonly used in a manufacturing environment. Each of the test platforms typically follows a separate calibration schedule. Furthermore, correction and adjustment of test station configuration is handled locally. In some situations, test station adjustment and calibration is performed manually by a technician or operator handling the station. When these individual efforts are aggregated over the entire manufacturing line or the manufacturing floor, the result is a substantial loss of time and resources. In some approaches, the user inserts an audit mode using golden units to post process test station data, to calibrate a specific test station. However, the manual solution increases the burden of data processing and inevitably causes the interruption of the smooth production test flow.

Therefore, what is desired is a method and a system for addressing instrument calibration and adjustment in manufacturing environments involving a plurality of test station. What is also desired is methods and systems for instrument calibration and adjustment that may be applied globally, in an automated fashion.

### SUMMARY OF THE DESCRIBED EMBODIMENTS

According to a first embodiment, a system for cloud computing to mitigate instrument variability in a test environment is provided. The system may include a test station having a controller, a processing circuit, and a memory circuit. In some embodiments the test station may be configured to receive and test a device under test (DUT). The system may further include a station server configured to provide a data correction algorithm to the memory circuit in the test station; and a data collection server configured to receive test data associated to the DUT in the test station. Accordingly, the data collection server may be further configured to provide a data correction algorithm for the test station to the station server.

In a second embodiment, a method for cloud computing to mitigate instrument variability in a test environment may include comparing a test time stamp with a reference clock. The method may include issuing a station flag based on a calibration schedule and receiving a test data from a test station. In some embodiments the method may include determining a variability in the test data and correlating the test data with a reference data.

Further according to a third embodiment, a method for collecting data from a test station to mitigate instrument variability in a manufacturing environment may include calibrating the test station with a reference data and testing a plurality of devices with the test station. The method may also include collecting test data from the test station; developing statistical information based on the collected data and the reference data on a server; and issuing a flag for the test station in accordance with the collected data and developed statistical information.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments may be better understood by reference to the following description and the accompanying drawings. Additionally, advantages of the described embodiments may be better understood by reference to the following description and accompanying drawings. These drawings do not limit any changes in form and detail that may be made to the described embodiments. Any such changes do not depart from the spirit and scope of the described embodiments.

FIG. 1 illustrates a system for cloud computing to mitigate instrument variability in a test environment, according to some embodiments.

FIG. 2A illustrates a system for cloud computing to mitigate instrument variability in a test environment, according to some embodiments.

FIG. 2B illustrates a cloud computing architecture in a manufacturing environment to mitigate instrument variability, according to some embodiments.

FIG. 3A illustrates an instrument sensitivity variability in a test environment, according to some embodiments.

FIG. 3B illustrates an instrument zero offset variability in a test environment, according to some embodiments.

FIG. 3C illustrates an instrument nonlinearity variability in a test environment, according to some embodiments.

FIG. 3D illustrates an instrument hysteresis variability in a test environment, according to some embodiments.

FIG. 3E illustrates an instrument random noise variability in a test environment, according to some embodiments.

FIG. 4 illustrates a system for cloud computing to mitigate instrument variability in a test environment, according to some embodiments.

FIG. 5 illustrates a flow chart in a method for cloud computing to mitigate instrument variability in a test environment, according to some embodiments.

FIG. 6 illustrates a chart of variability amplitudes in a method for cloud computing in a test environment, according to some embodiments.

FIG. 7A illustrates a chart of variability amplitudes in a method for cloud computing in a test environment, according to some embodiments.

FIG. 7B illustrates a chart of variability amplitudes in a method for cloud computing in a test environment, according to some embodiments.

FIG. 8A illustrates a chart of variability amplitudes in a method for cloud computing in a test environment, according to some embodiments.

FIG. 8B illustrates a chart of variability amplitudes in a method for cloud computing in a test environment, according to some embodiments.

FIG. 9 illustrates a flow chart in a method for collecting data from a test station to mitigate instrument variability in a manufacturing environment, according to some embodiments.

In the figures, elements referred to with the same or similar reference numerals include the same or similar structure, use, or procedure, as described in the first instance of occurrence of the reference numeral.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Embodiments as disclosed herein may be applied in test procedures for the fabrication of mobile and portable electronic devices or a class of similar products. In particular, embodiments consistent with the present disclosure may be applied for the manufacture of electronic devices including a liquid crystal display (LCD) or any other type of electronic display. Embodiments disclosed herein are not limited by the specific hardware and software used in the test environment. Test environments using different operating systems are consistent with the present disclosure. In some embodiments, methods and systems disclosed herein may include test environments with multiple test stations, where at least two test stations operate with different operating systems.

In large scale manufacturing environments it is desirable to replace human supervision and testing of devices at different stages of the manufacturing process with an automated mechanism. A plurality of test stations along an assembly line or an assembly floor performs multiple test procedures in parallel. The results of the test procedures vary from test station to test station, resulting in inter-station variability. Inter-station variability includes an intrinsic source in the device under test (DUT) itself. Inter-station variability may also include variability between instruments sets in different test stations, or inter-instrument variability. Automating the manufacturing process may become challenging in instances with large inter-station variability. For example, in the manufacturing of electronic devices testing of electronic displays is prone to inter-instrument variability due to the delicate calibration sensitivity of optical test instruments.

In the case of optical equipment, inter-instrument variability may occur from drift of optical power sources such as lamps, lasers, or light emitting diodes (LEDs) used for display testing. Furthermore, optical components such as lenses, mirrors, prisms, optical fibers and the like tend to get misaligned in time due to mechanical drift and also thermal stress, resulting in inter-instrument variability. The temporal variation in test instrumentation may be weeks, days, or even shorter. For example, an optical instrument may vary its performance during the day as the lamp used as a power source warms up at the start of the work shift. Other environmental factors such as humidity and dust accumulated on the optical components may contribute to inter-instrument variability as well.

More generally, inter-instrument variability may result from hardware differences even when the test station and ambient environments are controlled tightly. Here, inter-instrument differences include differences between a first test station and a second test station within a plurality of test stations in a test environment. For example, test results may be different even when the first test station is at approximately the same temperature as the second test station. Manufacturer specifications describe the test equipment performance characteristics, parameters or attributes that are covered under product warranty. Depending on the type of equipment, manufacturers may include both static and dynamic performance characteristics. And, since specification documents are used by manufacturers to market their products, they often contain additional information about features, operating condition limits, or other qualifiers that establish warranty terms. Some manufacturers may provide ample information detailing individual performance specifications, while others may only provide a single specification for overall accuracy. In some instances, specifications can be complicated, including numerous time-dependent, range dependent or other characteristics.

Embodiments as disclosed herein may be applied to test Color displays. Systems and methods consistent with the present disclosure are not limited to a specific type of testing. More generally, systems and methods consistent with the present disclosure may be applicable to acoustic testing procedures in electronic device manufacturing. Also, systems and methods as disclosed herein may be applicable to Camera testing procedures, such as used in digital camera manufacturing.

A test station according to some embodiments of the present disclosure accurately measures inter-station variability due to intrinsic properties of the DUT. Accordingly, systems and methods as disclosed herein remove inter-instrument variability from test data by creating a cloud computing architecture. In some embodiments, the cloud computing architecture includes a plurality of test stations globally controlled by at least a server device having access to the test stations. By receiving test data from multiple test stations an inter-station variability may be established. Accordingly, the inter-station variability may be compared with a reference data to establish an inter-instrument variability. Some embodiments may include a reference test station in the assembly line to provide the reference data. Furthermore, in some embodiments it is sufficient to distinguish the intrinsic variability related to the DUTs from inter-instrument variability. In some embodiments, the server uses the inter-instrument variability to modify the configuration of each test station independently. Thus, the inter-instrument variability may be substantially mitigated in an iterative process.

In embodiments as disclosed herein a server controlling a plurality of test stations forms an open loop iterative system suitable for automated, more generic, and fast testing procedures. Systems and methods consistent with the present disclosure may not be limited to manufacturing floor environments. Multiple labs and multiple devices may form a network controlled with a server in a data retrieving platform according to embodiments consistent with the present disclosure. In some embodiments, methods and systems as disclosed herein may be applied in a laboratory scale, or in an isolated test station. Accordingly, scenarios applying embodiments consistent with the present disclosure may be significantly different from one another. For example, a large scale manufacturing scenario may involve a plurality of test stations and a network coupling each of these test stations to one another and to at least one server.

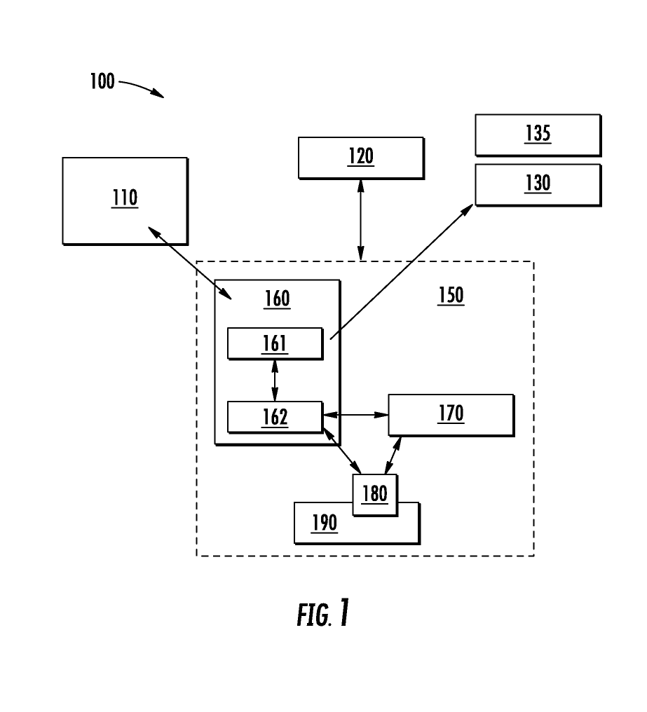

FIG. 1 illustrates a system 100 for cloud computing to mitigate instrument variability in a test environment, according to some embodiments. System 100 includes a station server 110, an assembly line server 120, and a data collection server 130 coupled to a test station 150. The cloud computing architecture may include a plurality of test stations 150 at each node of a network. Test station 150 includes a controller 160 having a data collection processor circuit 161 executing commands encoded in test station software stored in memory circuit 162. A fixture 190 has a DUT 180 fixedly attached to test station 150 so that hardware 170 performs a test on DUT 180. Hardware 170 may include an instrument set. The instrument set depends on the type of testing applied in test station 150. For example, an instrument set may include a colorimeter camera, and a spectrometer, when test station 150 tests electronic displays. In some embodiments, a test set in hardware 170 may include acoustic testing devices such as recorders. Further according to some embodiments, hardware 170 may include logical test devices to test memory arrays and other electronic processing circuits.

Based on the basic structures listed above, test station 150 may run in parallel with a plurality of similar test stations. Data collected by controller 160 is transmitted to data collection server 130 which creates database 135. Database 135 includes data provided by a plurality of test stations such as test station 150. Data collection server 120 may assess and reduce the inter-instrument variability within the inter-station data variability y using the global data stored in database 135.

In some embodiments, assembly line server 120 performs control sequence. For example, assembly line server 120 interacts with each test station 150 along an assembly line to ensure that DUT 180 follows the appropriate assembly procedure. Accordingly, assembly line server 120 may issue an alert flag when DUT 180 has skipped a certain test station along the assembly line. Test station server 110 provides test protocols and algorithms to test station 150. Accordingly, test station server 110 may install software 162 in controller 160 such that when executed by processor 161 test station 150 performs the desired test protocols and algorithms. For example, in some embodiments the test protocols and algorithms may correct a data collection process by hardware 170, reducing inter-instrument variability.

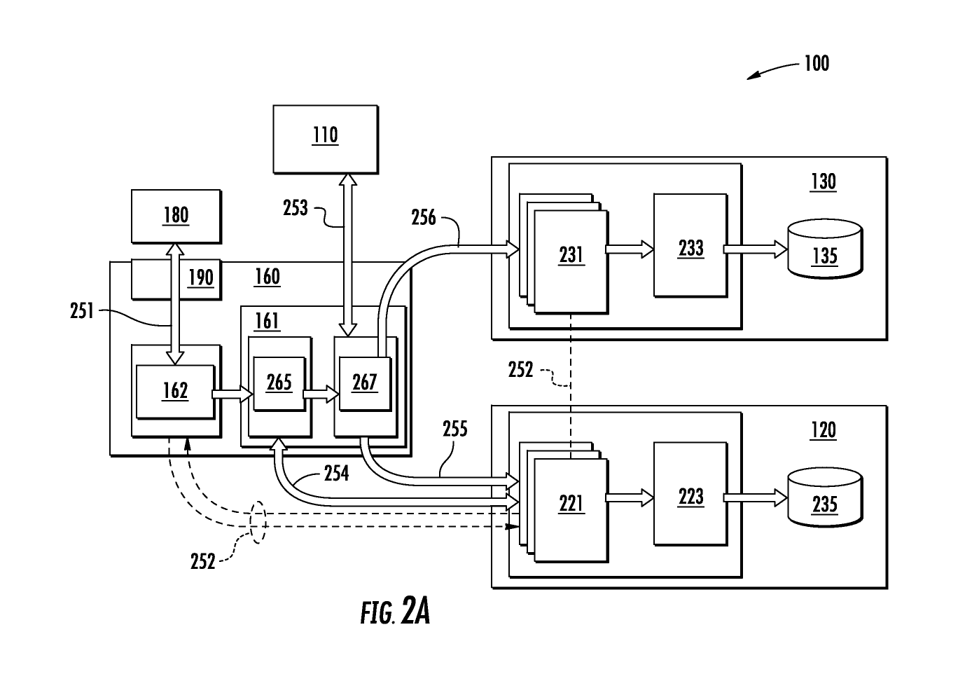

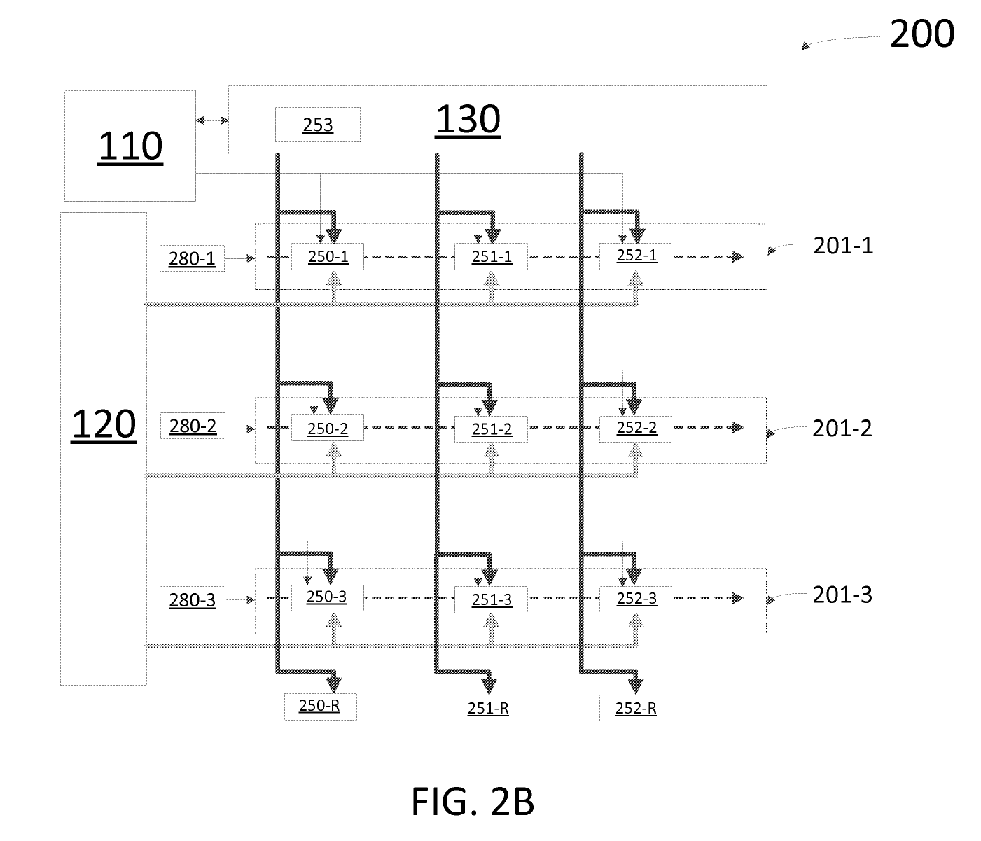

FIG. 2A illustrates system 100 for cloud computing to mitigate instrument variability in a test environment, according to some embodiments. FIG. 2A illustrates a test station data collection structure according to some embodiments. Station server 110 provides software and correction algorithms to controller 160 through communication channel 253. In some embodiments, communication between controller 160 and station server 110, assembly line server 120, and data collection server 130 is through data collection processor 161. In some embodiments, data collection processor 161 may further include a first processor 265 and a second processor 267. First processor 265 may receive data provided by software 162 after performing a test on DUT 180. First processor 265 may also communicate with assembly line server 120 through communication line 254. Accordingly, assembly line server 120 may determine whether DUT 180 is in the appropriate test station. Second processor 267 provides data to data collection server 130 through communication channel 256. Second processor 267 may also provide information to assembly line server 120 through communication channel 255.

Assembly line server 120 may include an assembly line load balancer circuit 221, and an assembly line processor circuit 223. Likewise, data collection server 130 may include a data collection load balancer circuit 231, and a data collection processing circuit 233. Load balancer circuits 221 and 231 manage the data provided to each of assembly line server 120 and data collection server 130 from the nodes in a cloud computing network consistent with the present disclosure. Accordingly, the nodes in a cloud computing network as disclosed herein may include a plurality of test stations in a manufacturing floor (e.g., test station 150, cf. FIG. 1). Data received and processed by servers 120 and 130 are stored in assembly line database 235 and data collection database 135, respectively.

FIG. 2B illustrates a cloud computing architecture 200 in a manufacturing environment to mitigate instrument variability, according to some embodiments. Cloud computing architecture 200 includes a plurality of test stations forming the nodes of a network controlled by station server 110, assembly line server 120, and data collection server 130. Cloud computing architecture 200 includes a plurality of factory assembly lines 201-1, 201-2, and 201-3, collectively referred hereinafter as assembly lines 201. Cloud computing architecture 200 includes DUTs 280-1, 280-2, and 280-3, collectively referred hereinafter as DUTs 280. Assembly line 201-1 includes a series of test stations 250-1, 251-1, and 252-1. Accordingly, DUT 280-1 is processed along assembly line 201-1 and is tested at each step by test stations 250-1, 251-1, and 252-1. A similar configuration is illustrated in FIG. 2B for assembly lines 201-2 and 201-3, each processing DUT 280-2 and 280-3, respectively.

A manufacturing environment as illustrated in FIG. 2B includes three test stages. For example, a first test stage may include test stations 250-1, 250-2, and 250-3, collectively referred hereinafter as test stations 250. A second test stage may include test stations 251-1, 251-2, and 251-3, collectively referred hereinafter as test stations 251. And a third test stage may include test stations 252-1, 252-2, and 252-3, collectively referred hereinafter as test stations 252. A test stage may be associated with a different step in the manufacturing of an electronic device. Thus, each test stage may include different software and hardware (e.g., software 162 and hardware 170, cf. FIG. 1). In some embodiments, each test stage may further include a reference station. For example, as illustrated in FIG. 2B the first test stage may include reference station 250-R. Likewise, the second test stage may include reference station 251-R. And the third test stage may include reference station 252-R. Reference stations 250-R, 251-R, and 252-R may provide reference data to data collection server 130, to compare with date from test stations 250, 251, and 252, respectively. In that regard, reference test stations 250-R, 251-R, and 252-R may include hardware calibrated according to a high industry standard. Reference stations 250-R, 251-R, and 252-R may include golden standard test instrumentation used for quality control of the manufacturing process. For example, in some embodiments, reference test stations 250-R, 251-R, and 252-R may include hardware calibrated according to standards provided by the National Institute of Standards and Technology (NIST).

Station server 110 has access to each of test stations 250, 251, and 252 in cloud computing architecture 200. Station server 110 may have access to a controller in each of the test stations (e.g., controller 160, cf. FIG. 1). In that regard, station server 110 may provide an image of an operating system (OS) to the controller. Furthermore, station server 110 may have privileges to install, uninstall, and modify software in the test station (e.g., software 162, cf. FIG. 1).

Assembly line server 120 also has access to each of test stations 250, 251, and 252. In some embodiments, assembly line server 120 guarantees a standardized process control to ensure a proper test sequence is followed for a given DUT. For example, assembly line server 120 may provide hash protocol and logic tests to ensure that DUTs 280 follow the appropriate order of test stages 250, 251, and 252. Assembly line server 120 may provide tests and protocols for each of assembly lines 201-1, 201-2, and 201-3.

Data collection server 130 controls access to test data from each of test stations 250, 251, and 252. Furthermore, as illustrated in FIG. 2B, data collection server 130 has access to reference data provided by reference test stations 250-R, 251-R, and 252-R. Based on the data retrieved by data collection server 130 from the test stations and the reference test stations, a correction protocol 253 is generated. In some embodiments, correction protocol 253 includes correction data and algorithms for each of test stations 250, test stations 251, and test stations 252. Correction protocol 253 may thus include a plurality of protocols destined to each of a plurality of test stations. Correction protocol 253 may be provided to test station server 110, so that the correction protocol is installed on each of the test stations in the cloud computing architecture.

The number of stages in a manufacturing environment consistent with the present disclosure is not limiting. Likewise, the number of assembly lines in a manufacturing environment consistent with the present disclosure is not limiting. Furthermore, while FIG. 2B shows the entire network enclosed within a boundary, the specific geographic location of each of the elements in cloud computing architecture 200 is not limiting. Thus, line assemblies 201 may be geographically remote from each other. Servers 110, 120m and 130 may also be geographically remote from each other, and from each of assembly lines 201.

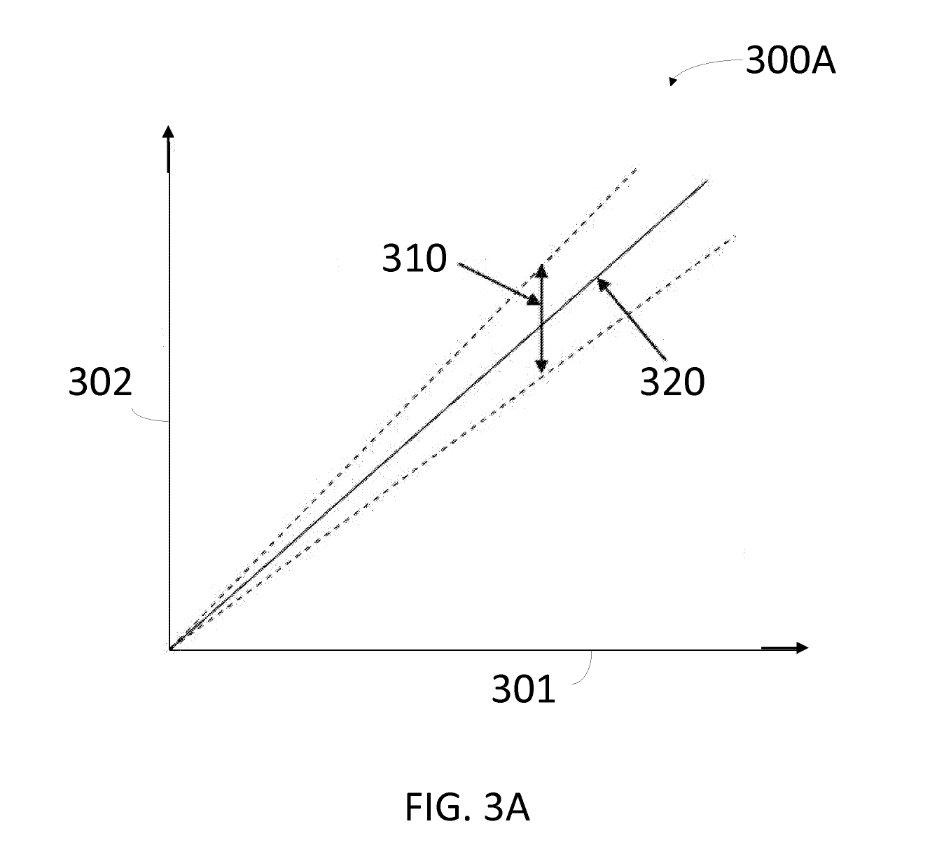

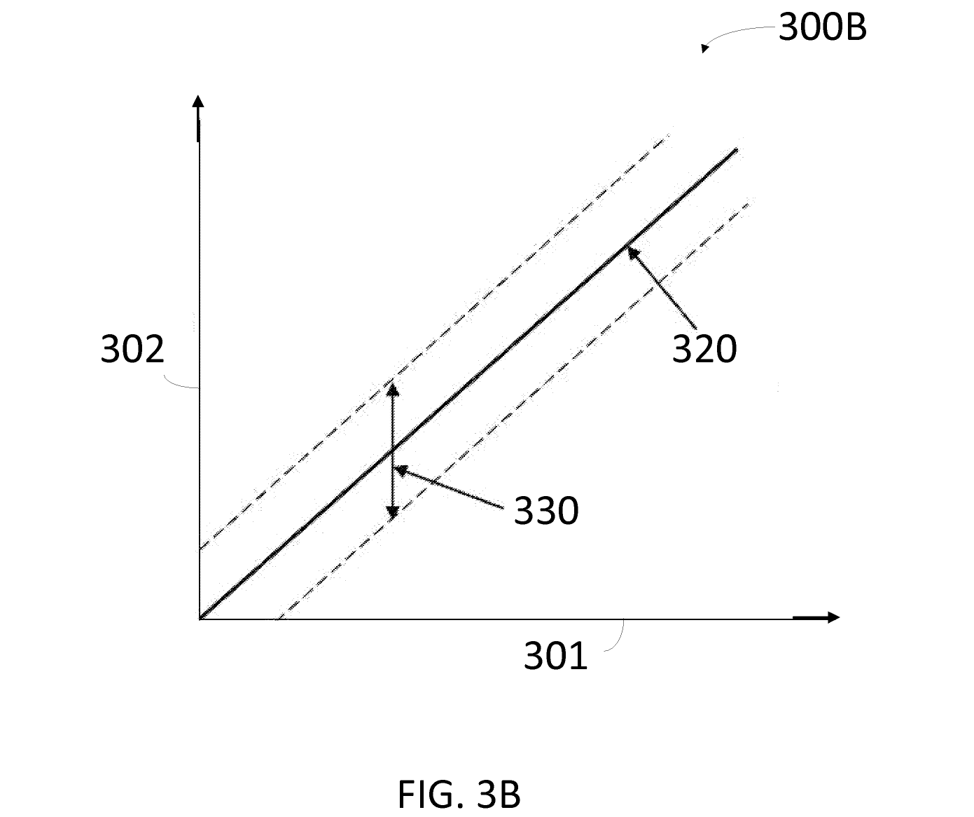

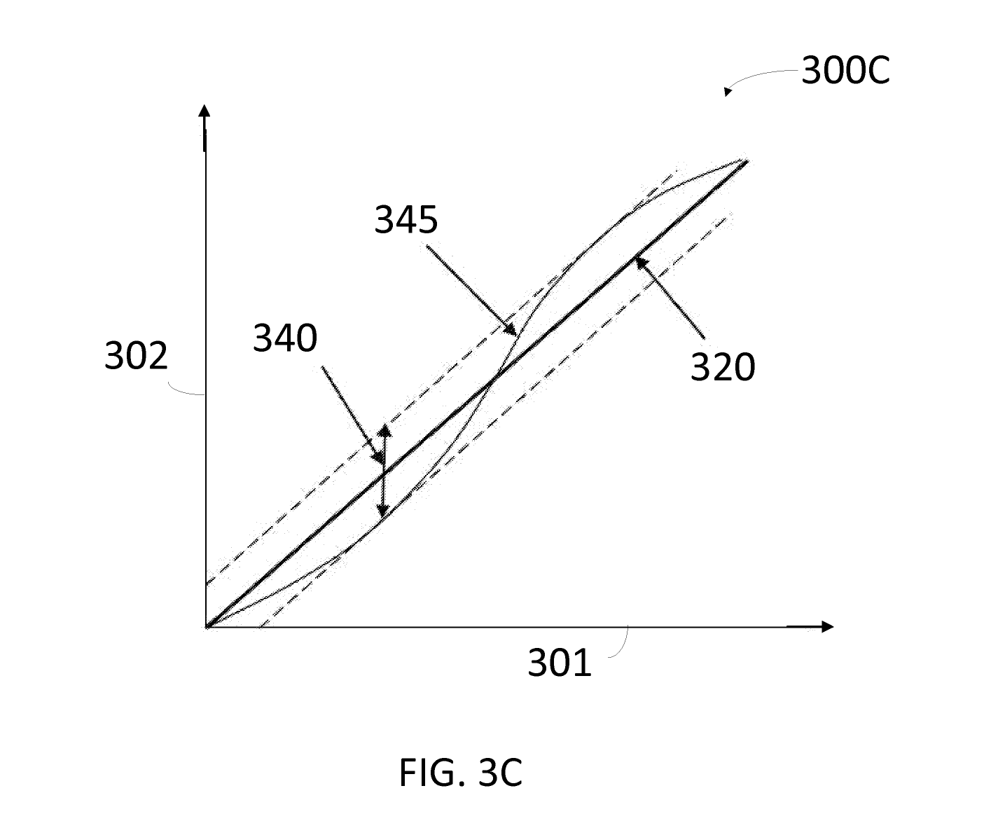

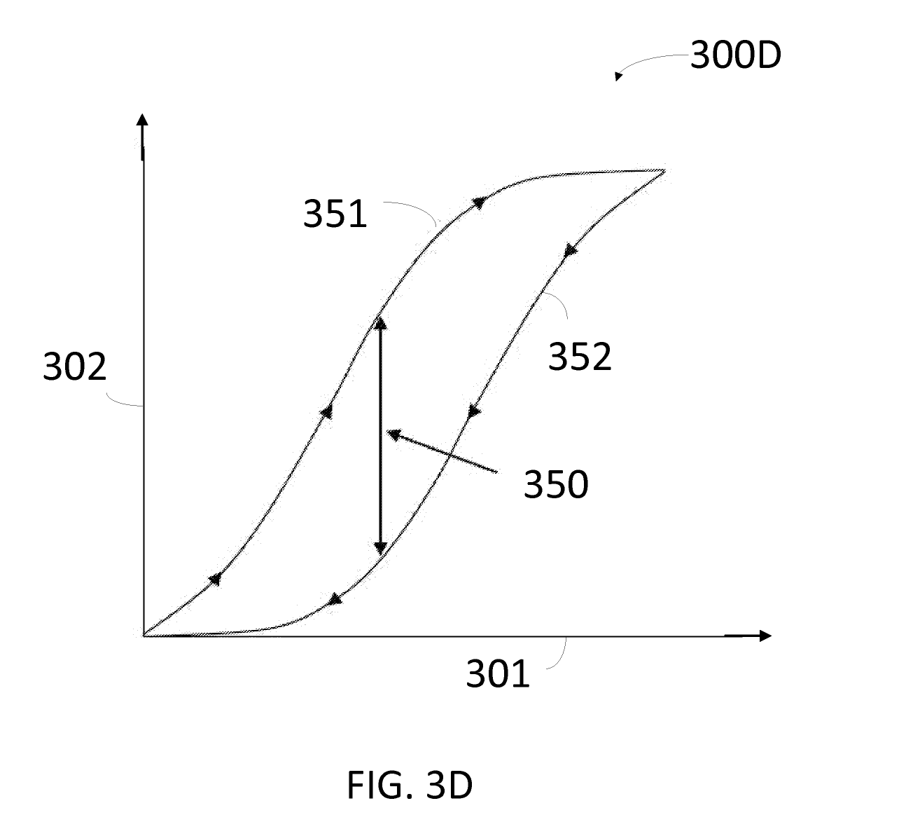

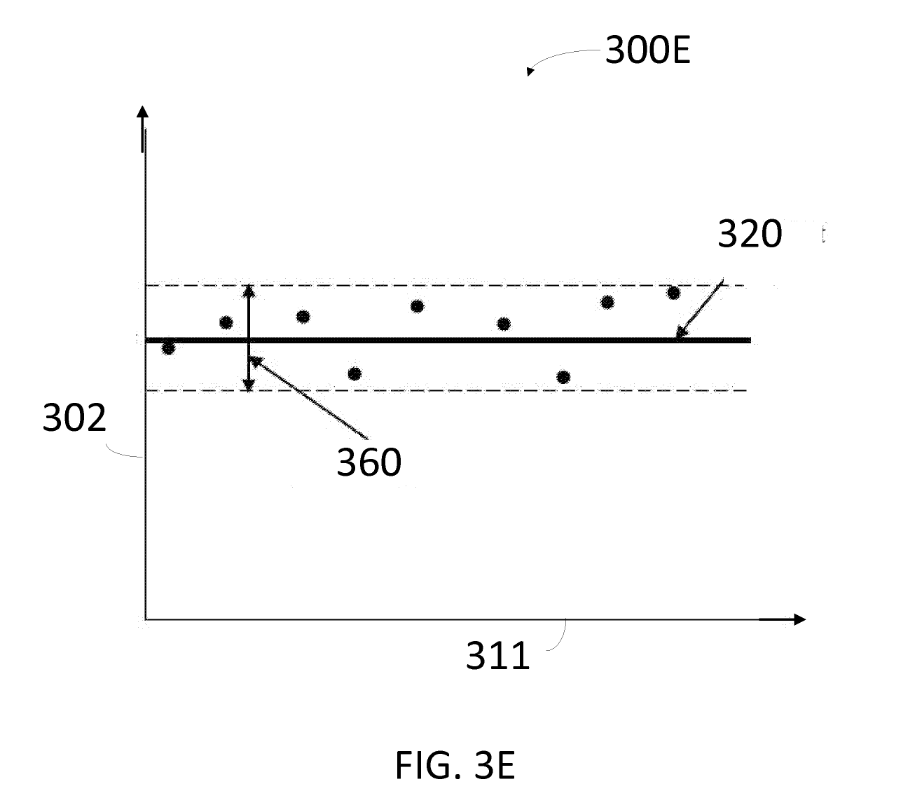

FIGS. 3A-3E illustrate static performance characteristics of test station 150 according to embodiments of the present disclosure. Accordingly, FIGS. 3A-3E provide an indication of how an instrument, transducer or signal conditioning device in hardware 170 responds to a steady-state input at one particular time. Charts 300A-300E in FIGS. 3A-3E reflect an instrument response curve 320 for a test station 150, according to some embodiments having an instrument variability 310 (chart 300A, cf. FIG. 3A), 330 (chart 300B, cf. FIG. 3B), 340 (chart 300C, cf. FIG. 3C), 350 (chart 300D, cf. FIG. 3D), and 360 (chart 300E, cf. FIG. 3E). Charts 300A-300D in FIGS. 3A-3D include an abscissa axis 301 for a full scale of an instrument input, and an ordinate axis 302 for a full scale of an instrument output. Accordingly, the abscissa and ordinate in FIGS. 3A-3D may be provided in percent values, and have a minimum value of 0% and a maximum value of 100%. In addition to sensitivity (or gain) and zero offset, other static characteristics include nonlinearity, repeatability, hysteresis, resolution, noise and accuracy. Inter-instrument variability due to nonlinearity, hysteresis and repeatability may not be eliminated in some embodiments, but the uncertainty due to this variability can be quantified.

Embodiments of the present disclosure include calibration procedures performed on test station 150 on a periodic basis. Also, in embodiments as disclosed herein data collection server 130 may determine that test station 150 provides data departing beyond an acceptable threshold, warranting a calibration procedure on test station 150. In addition, data collection server 120 may store the specific response curves (charts 300A-300E) for each of test stations 150 in the network. Having this information, data collection server 130 may provide correction algorithms to station server 110 specifically designed for each test station 150. Thus, station server 110 may install a correction algorithm in software 162 of test station 150, including specific performance characteristics of each test station 150. In that regard, instrument variability 310, 330, 340, 350, and 360 may indicate threshold values to trigger a calibration procedure for a specific test station. Thus, when data collection server 120 determines that a response curve 320 is beyond an instrument variability, a calibration procedure is scheduled for the test station. Each of these static performance characteristics will be discussed in more detail below.

FIG. 3A illustrates an instrument sensitivity variability 310 in a test environment, according to some embodiments. Sensitivity is the ratio of the output signal to the corresponding input signal for a specified set of operating conditions. Accordingly, sensitivity is the slope of curve 320. For example, in some embodiments sensitivity is the ratio of an amplifier output signal voltage to an input signal voltage, as follows

$$Sensitivity ( or Gain ) = \frac{Δ Out}{Δ In}$$

If the amplification ratio is less than unity, then the sensitivity reflects an attenuation. And when the ration is greater than unity, the sensitivity reflects a gain.

The sensitivity of a measuring device or instrument may depend on the principle of operation and design. The specific principle of operation and design of a measuring device in a test station are not limiting of methods and systems consistent with embodiments disclosed herein. Many devices or instruments are designed to have a linear relationship between input and output signals and thus provide a constant sensitivity over the operating range. As a result, instrument manufacturers often report a nominal or ideal sensitivity with a stated error or accuracy. Response curve 320 may be linear but the slope in chart 300A may differ from a specified nominal or ideal sensitivity.

FIG. 3B illustrates an instrument zero offset variability 330 in a test environment, according to some embodiments. Zero offset variability 330 occurs when the device exhibits a non-zero output for a zero input. A zero offset value is assumed constant at any input level and, therefore, contributes by a fixed amount to the measurement output (ordinate 302). In some embodiments, zero offset variability 330 may be different from zero after a data correction algorithm is applied, since knowledge of the true offset value may not be complete. Zero offset variability 330 may be reduced by adjustment of hardware 170 to a desired level.

FIG. 3C illustrates an instrument nonlinearity variability 340 in a test environment, according to some embodiments. Nonlinearity is a measure of the deviation of response curve 320 from a linear relationship (cf. FIGS. 3A and 3B). Nonlinearity variability 340 exists when the actual sensitivity (slope of response curve 320) is not constant over the input range (abscissa 301), as shown in FIG. 3C. Thus, at any given input the output value varies with magnitude over and below an ideal response over a range of inputs. Nonlinearity variability 340 may be defined by the magnitude of the output difference from ideal behavior over the full input range (abscissa 301). Accordingly, nonlinearity variability 340 may be a percentage of the full scale output of the device (ordinate 302).

FIG. 3D illustrates an instrument hysteresis variability 350 in a test environment, according to some embodiments. Hysteresis variability 350 indicates that the output of the device is dependent upon the direction and magnitude by which the input is changed. For example, the response of the instrument may follow curve 351 when the input values in abscissa 301 are increasing. And the response of the instrument may follow curve 352 when the input values in abscissa 301 are decreasing. At any input value, hysteresis variability 350 can be expressed as the difference between curves 351 and 352, as shown in FIG. 3D. Hysteresis variability 350 may be fixed at any given input, but can vary with magnitude and sign over a range of inputs. Hysteresis variability 350 may be reported as a percent of full scale.

FIG. 3E illustrates an instrument random noise variability 360 in a test environment, according to some embodiments. Random noise variability 360 is intrinsic to an instrument. The abscissa 311 in chart 300E indicates time, and the ordinate 302 indicates the instrument output for a constant input. Chart 300E illustrates output 302 varying from observation to observation for a constant input, as shown in FIG. 3E. In some embodiments, random noise variability 360 may also indicate a non-repeatability value. Furthermore, in some embodiments random noise variability 360 may be considered a short-term stability value. Random noise variability 360 may change in magnitude and sign over a range of inputs. Data collection server 130 may provide signal conditioning and filtering algorithms to test station 150 to reduce random noise variability. Noise is typically specified as a percentage of the full scale output.

FIG. 4 illustrates a system 400 for cloud computing to mitigate instrument variability in a test environment, according to some embodiments. The instrument variability may include any one of instrument variability 310, 330, 340, 350, and 360, discussed in detail above. A cloud computing network architecture as disclosed herein provides real time post processing of data from test station 150. The cloud computing network architecture monitors and mitigates inter-station variability by providing data correction algorithms designed for each test station. In some embodiments, the cloud computing network architecture may determine that a given test station is due for a calibration procedure. In the exemplary embodiment illustrated in FIG. 4, a manufacturing floor including Red-Blue-Green-White (RGBW, also referred to as ‘four-color’ test station) test stations 450-1, 450-2 and 450-3, is operated. RGBW test stations 450-1, 450-2, and 450-3 (hereinafter collectively referred to as RGBW test stations 450) may include each a similar set of test instrumentation. Furthermore, the network architecture in FIG. 4 includes a quality control (QC) RGBW station 460. QC-RGBW station 460 may be a reference station used for quality control, as described in detail above (e.g., reference stations 250-R, 251-R, and 252-R, cf. FIG. 2B). RGBW station 460 may be used for monitoring performance variability of RGBW test stations 450. Accordingly, data collection server 130 collects test data from RGBW test stations 450 and also from QC-RGBW station 460. Data collection server 130 may determine the instrument variability for each RGBW test station 450 using the data from QC-RGBW station. With the instrument variability for each of RGBW test station 450, data collection server 130 provides station server 110 with correction algorithms 453 specifically designed for each RGBW test station 450. Station server 110 in turn provides each of RGBW test stations 450 with the appropriate correction algorithms 453. Accordingly, data collection server 130 provides a corrected data 452 to database 135, for further analysis or reporting.

In embodiments consistent with the present disclosure, FIG. 4 illustrates an iterative process controlled by data collection server 130. Thus, data collection server 130 may provide a plurality of data correction algorithms to each of RGBW test stations 450 until an overall measure of the variability is below a tolerance and corrected data 452 may be stored in database 135. In some embodiments, a data correction algorithm 453 provided to an RGBW test station 450 may be a color correction matrix.

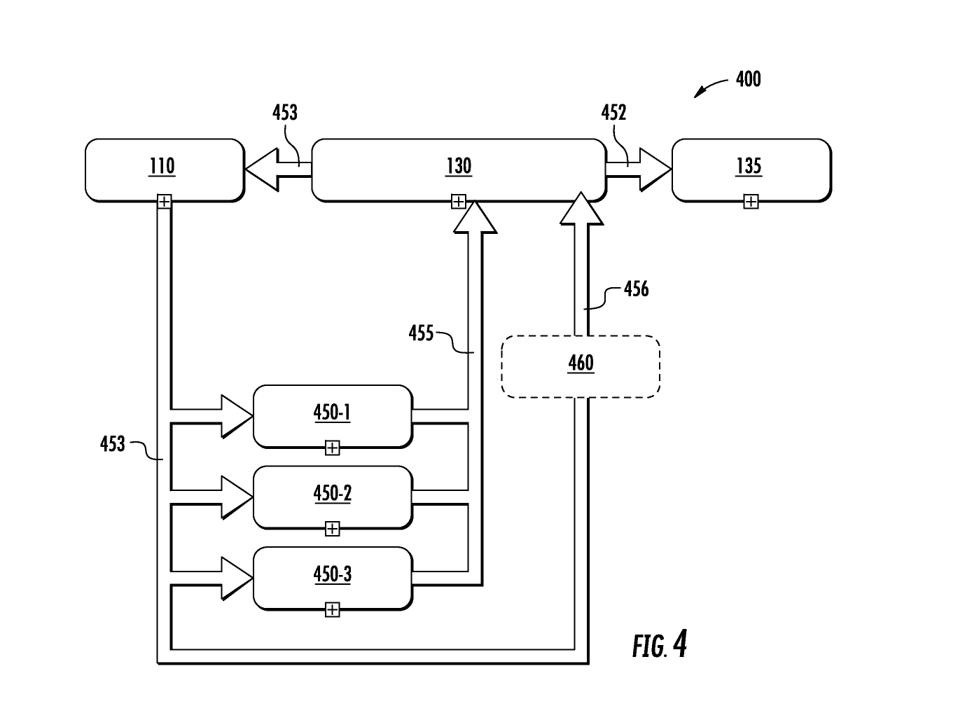

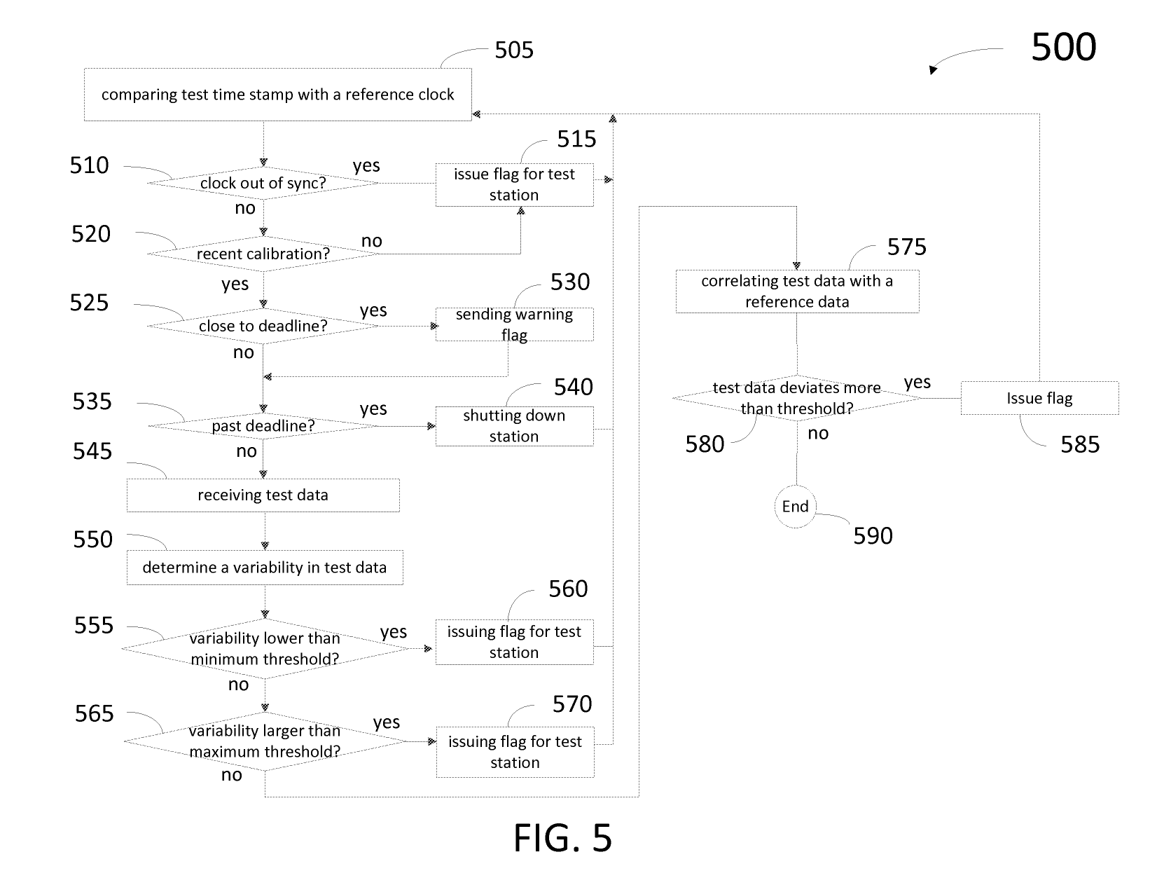

FIG. 5 illustrates a flow chart in a method 500 for cloud computing to mitigate instrument variability in a test environment, according to some embodiments. Steps in method 500 may be performed partially or in full by any one of a plurality of servers in a system for cloud computing in a test environment (e.g., servers 110, 120, and 130 in system 100, cf. FIG. 1). Some embodiments may include a system such as system 400 performing method 500 (cf. FIG. 4). For example, a test station in method 500 may include a measuring test station and a reference test station (e.g., RGBW test stations 450 and QC-RGBW station 460, cf. FIG. 4). Accordingly, method 500 may include steps performed by a test station (e.g., test station 150, cf. FIG. 1, and RGBW station 450, cf. FIG. 4) and steps performed by a reference test station (e.g., reference stations 250-R, 252-R, and 252-R, cf. FIG. 2B, and QC-RGBW station 460, cf. FIG. 4).

Step 505 includes comparing a test time stamp with a reference clock. Step 505 may include comparing an end test time stamp with a standard reference. When a clock in the test station is found to be out of synchronization in step 510, step 515 includes flagging test stations that have gone without calibration for over a week. Step 525 includes determining whether a particular test station is close to a calibration deadline. In step 530 test stations may be given a warning flag as the calibration deadline approaches, as determined in step 525. Step 540 includes shutting down a test station when step 535 determines that a calibration deadline is overdue, or if the test station is past a calibration date without calibration. Step 540 may further include performing a calibration procedure on the test station that has been shut down.

Step 545 includes receiving test data. In some embodiments step 545 may further include analyzing incoming test data. In some embodiments, step 545 may include receiving a plurality of test data sets from the test station, where the plurality of test data sets is originated by a plurality of devices under test (DUTs) in the test station. Step 550 includes determining variability in the received test data. Variability in test data may include inter-instrument variability, according to some embodiments. That is, in some embodiments step 550 may include determining variability in data collected from different test stations. In some embodiments, step 550 may include performing a statistical analysis on the data collected from the plurality of test stations. Step 555 includes comparing the observed variability with a minimum threshold. Step 560 includes issuing a warning flag when the variability is lower than a minimum threshold, or zero. Step 565 includes comparing the determined variability with a maximum threshold when the fluctuations are larger than the minimum threshold. Step 570 includes issuing a flag if the variability is larger than the maximum threshold. The minimum threshold and the maximum threshold define a pre-selected acceptable range.

Step 575 includes correlating the data from a measurement test station with the reference data from a reference station. In some embodiments, step 575 may include correlating data from all test stations with the reference station. Accordingly, step 575 may further include forming a data correction algorithm for the test station based on the determined variability in the test data (e.g., data correction algorithm 453, cf. FIG. 4). Step 580 includes determining whether or not a reference station data deviates more than a reference threshold from a test station data, for the same DUT. The result in step 580 may indicate a problem with a measurement test station, or with a plurality of measurement test stations. For example, when step 580 determines a deviation between test station data and reference station data larger than the reference threshold the test station is flagged as suspect in step 585. Method 500 is then re-started from step 505. When step 580 determines a deviation less than the reference threshold, step 590 includes stopping method 500.

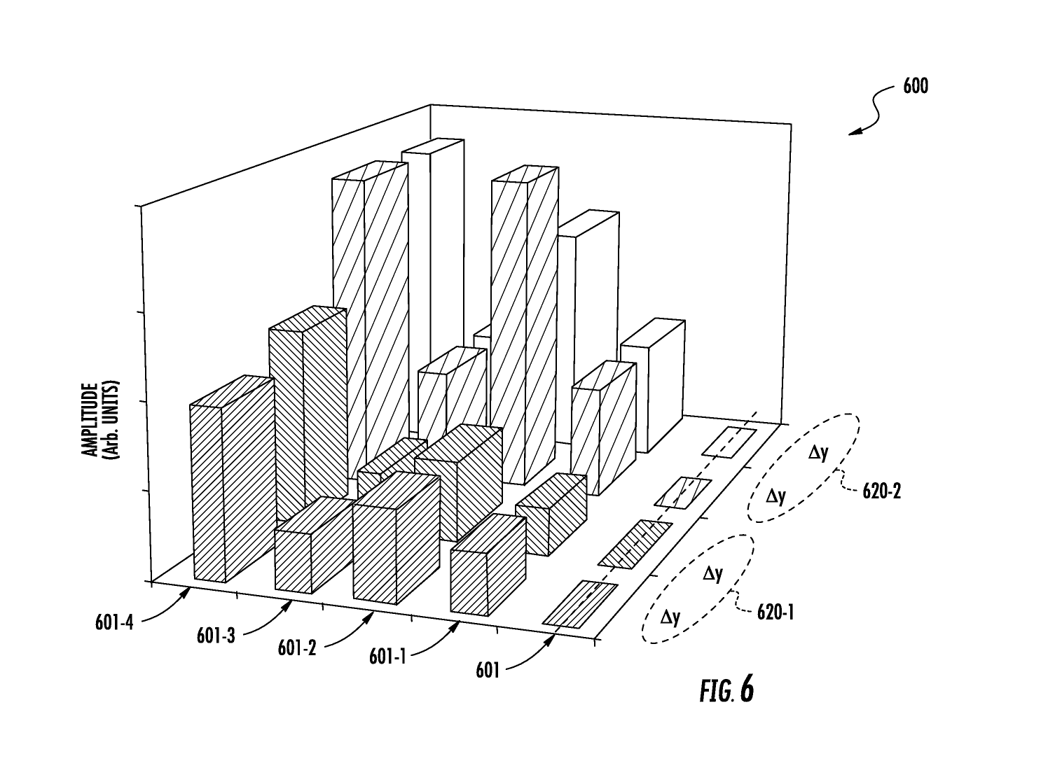

The algorithm involved to mitigate instrument variability (e.g., correction algorithm 453, cf. FIG. 4) may include a color correction matrix, according to some embodiments. In what follows (FIGS. 6, 7A-7B, and 8A-8B), a color correction matrix calculation will be disclosed in detail, in connection with a cloud computing architecture consistent with embodiments disclosed herein (e.g., cloud computing architecture 200, cf. FIG. 2B). A color correction matrix may be used also in connection with a cloud computing architecture including RGBW test stations and a QC-RGBW reference station as a reference station (cf. FIG. 4). In that regard, the color correction matrix may be used with (Red-Green, and Blue) RGB color data from an electronic display manufacturing environment. Accordingly, the RGB color data may be used in a 3-dimensional representation using tristimulus chromaticity coordinates XYZ, as one of ordinary skill in the art of colorimeters will know. One of ordinary skill will recognize that the specific details of a color correction matrix as disclosed in reference to FIGS. 6, 7A-7B, and 8A-8B below is not limiting of embodiments consistent with the present disclosure.

FIG. 6 illustrates a chart 600 of variability amplitudes in a method for cloud computing in a test environment (e.g., method 500, cf. FIG. 5), according to some embodiments. Chart 600 is a three-dimensional (3D) representation of variability amplitudes. In chart 600 a depth-axis represents coordinate variability values 620-1 and 620-2. Variability values 620-1 may be root-mean-square (RMS) variability values in X and Y coordinates, according to some embodiments. In some embodiments, variability values 620-2 may be maximum variability values in X and Y coordinates. A width axis in chart 600 represents different algorithms used in a method for cloud computing in a test environment. Accordingly, algorithm 610 may be a four color algorithm (RGBW algorithm). Algorithm 601-1 may include an ASTM-96 algorithm, algorithm 601-2 may include an ASTM-92 algorithm, algorithm 601-3 may include an RGB method, and algorithm 601-4 may include a direct computation of the original error in the data. A height axis in chart 600 represents instrument variability amplitude, in arbitrary units. The specific data correction algorithm listed in the width axis of FIG. 6 in methods for cloud computing is not limiting of embodiments consistent with the present disclosure. As an exemplary embodiment, the RGBW algorithm for data correction will be described in detail below.

The primary colors (red, green, and blue) and a white color of an electronic display for test are measured by a target instrument (a colorimeter being optimized) and a reference instrument (a reference tristimulus colorimeter or spectro-radiometer). From the chromaticity coordinates (Xm,R, Ym,R), (Xm,G, Ym,G), and (Xm,B, Ym,B) of red, green, and blue measured by the target instrument, the relative tristimulus values of the primary colors from the target instrument are defined by

$$\begin{matrix}{M}_{RGB} = [ \begin{matrix}{X}_{m , R} & {X}_{m , G} & {X}_{m , B} \\ {Y}_{m , R} & {Y}_{m , G} & {Y}_{m , B} \\ {Z}_{m , R} & {Z}_{m , G} & {Z}_{m , B}\end{matrix} ] \\ = [ \begin{matrix}{x}_{m , R} & {x}_{m , G} & {x}_{m , B} \\ {y}_{m , R} & {y}_{m , G} & {y}_{m , B} \\ {z}_{m , R} & {z}_{m , G} & {z}_{m , B}\end{matrix} ] [ \begin{matrix}{k}_{m , R} & 0 & 0 \\ 0 & {k}_{m , G} & 0 \\ 0 & 0 & {k}_{m , B}\end{matrix} ]\end{matrix} \\ where {k}_{m , R} + {k}_{m , G} + {k}_{m , B} = 1.$$

Km,R, Km,G and Km,B are the relative factors for measured luminance of each display color, and are now unknown variables. z with any sub script s is obtained from Xs and ys by zs=1−Xs-ys.

From the chromaticity coordinates (Xr,R, Yr,R), (Xr,G, Yr,G), and (Xr,B, Yr,B) of red, green, and blue measured by the reference instrument, the relative tristimulus values of the primary colors from the reference instrument are defined by

$$\begin{matrix}{N}_{RGB} = [ \begin{matrix}{X}_{r , R} & {X}_{r , G} & {X}_{r , B} \\ {Y}_{r , R} & {Y}_{r , G} & {Y}_{r , B} \\ {Z}_{r , R} & {Z}_{r , G} & {Z}_{r , B}\end{matrix} ] \\ = [ \begin{matrix}{x}_{r , R} & {x}_{r , G} & {x}_{r , B} \\ {y}_{r , R} & {y}_{r , G} & {y}_{r , B} \\ {z}_{r , R} & {z}_{r , G} & {z}_{r , B}\end{matrix} ] [ \begin{matrix}{k}_{r , R} & 0 & 0 \\ 0 & {k}_{r , G} & 0 \\ 0 & 0 & {k}_{r , B}\end{matrix} ]\end{matrix} \\ where {k}_{r , R} + {k}_{r , G} + {k}_{r , B} = 1.$$

Kr,R, Kr,G, and Kr,B are the relative factors for luminance of each display color. Based on the additivity of tristimulus values, and with (Xm,W, Ym,W) and (Xr,W, Yr,W) being the chromaticity coordinates of the display for the white color measured by the target instrument and the reference instrument, respectively, the following relationships hold:

$$[ \begin{matrix}{x}_{m , W} \\ {y}_{m , W} \\ {z}_{m , W}\end{matrix} ] = [ \begin{matrix}{x}_{m , R} & {x}_{m , G} & {x}_{m , B} \\ {y}_{m , R} & {y}_{m , G} & {y}_{m , B} \\ {z}_{m , R} & {z}_{m , G} & {z}_{m , B}\end{matrix} ] [ \begin{matrix}{k}_{m , R} \\ {k}_{m , G} \\ {k}_{m , B}\end{matrix} ] \\ [ \begin{matrix}{x}_{r , W} \\ {y}_{r , W} \\ {z}_{r , W}\end{matrix} ] = [ \begin{matrix}{x}_{r , R} & {x}_{r , G} & {x}_{r , B} \\ {y}_{r , R} & {y}_{r , G} & {y}_{r , B} \\ {z}_{r , R} & {z}_{r , G} & {z}_{r , B}\end{matrix} ] [ \begin{matrix}{k}_{r , R} \\ {k}_{r , G} \\ {k}_{r , B}\end{matrix} ]$$

The white color of the display can be of any intensity combination of the three primary colors. The values (k m,R, Km,G, K m,B) and (K r,R, K r,G, Kr,B) are now obtained by solving above two equations as

$$[ \begin{matrix}{k}_{r , R} \\ {k}_{r , G} \\ {k}_{r , B}\end{matrix} ] = {[ \begin{matrix}{x}_{r , R} & {x}_{r , G} & {x}_{r , B} \\ {y}_{r , R} & {y}_{r , G} & {y}_{r , B} \\ {z}_{r , R} & {z}_{r , G} & {z}_{r , B}\end{matrix} ]}^{- 1} [ \begin{matrix}{x}_{r , W} \\ {y}_{r , W} \\ {z}_{r , W}\end{matrix} ] \\ [ \begin{matrix}{k}_{m , R} \\ {k}_{m , G} \\ {k}_{m , B}\end{matrix} ] = {[ \begin{matrix}{x}_{m , R} & {x}_{m , G} & {x}_{m , B} \\ {y}_{m , R} & {y}_{m , G} & {y}_{m , B} \\ {z}_{m , R} & {z}_{m , G} & {z}_{m , B}\end{matrix} ]}^{- 1} [ \begin{matrix}{x}_{m , W} \\ {y}_{m , W} \\ {z}_{m , W}\end{matrix} ]$$

Accordingly, in embodiments where vectors [k_{rR}, k_{rG}, k_{rB}] and [k_{mR}, k_{mG}, k_{mB}] are desirably similar or equal, correction matrix R may be given by

R=N_{RGB}·M_{RGB}⁻¹

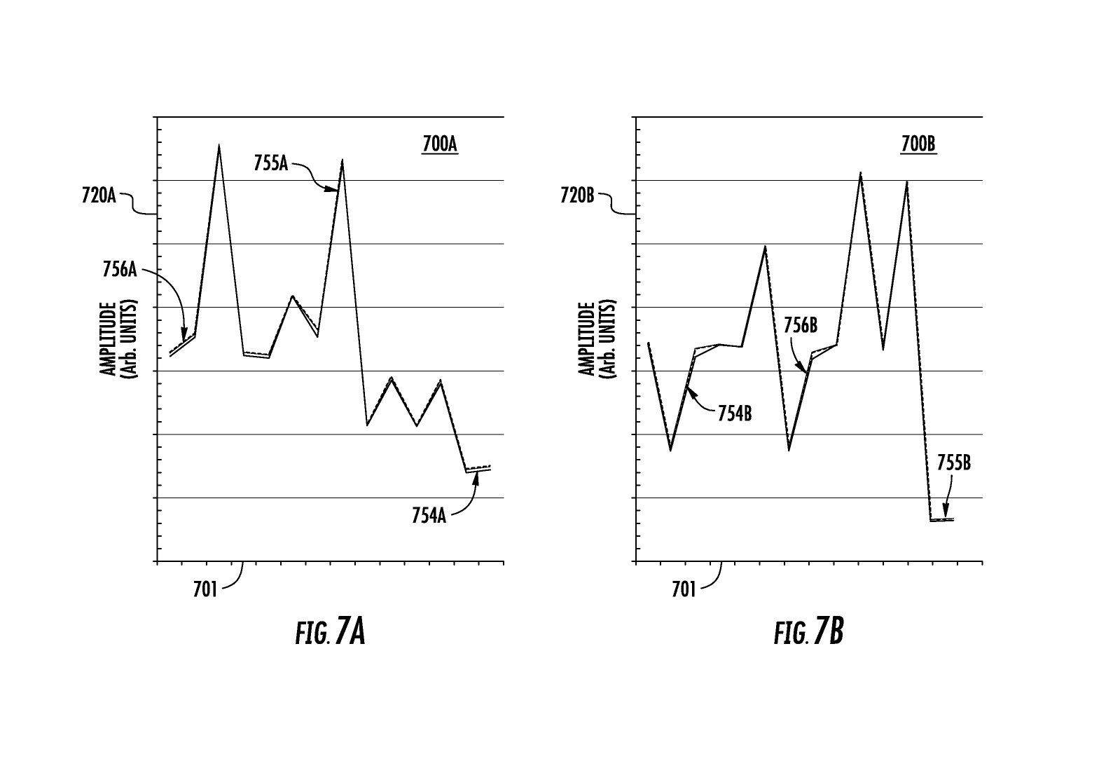

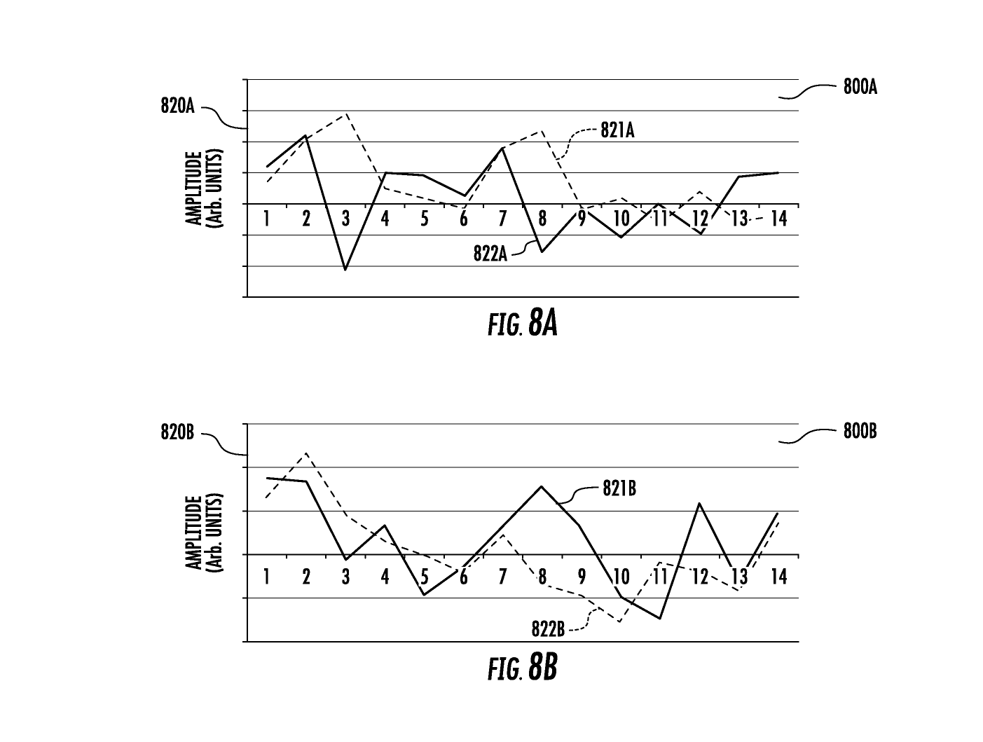

Data in FIGS. 7A-7B, and FIGS. 8A-8B illustrate results obtained in an embodiment of a cloud computing architecture where the RGBW test station uses a PR-920× Digital Video Photometer as part of the test hardware. And the QC-RGBW reference station is a PR-655 SpectraScan reference device. Other devices may be used without limitation of embodiments consistent with the present disclosure. X, Y and Z measurements of 68 pre-determined test points were taken consecutively with the test RGBW station and the reference RGBW station on a typical liquid crystal display (LCD) screen. Accordingly, the LCD screen may be an electronic display for testing in a manufacturing environment consistent with the present disclosure. Data included in FIGS. 7A-7B, and FIGS. 8A-8B was collected using the RGBW test station and the RGBW reference station on 68 test patterns.

FIG. 7A illustrates a chart 700A of variability amplitudes in a method for cloud computing in a test environment, according to some embodiments. Specifically, FIG. 7A illustrates variability amplitudes for the X-coordinate in the tristimulus representation of a color chart. Accordingly, FIG. 7A illustrates an uncorrected X-test data set 755A, a reference X-data set 756A, and a corrected X data set 754A.

An algorithm was developed to achieve the best solution to the problem of how to manipulate the data by vector multiplication to provide the best solution. A re-mapping of the RGBW test data was sought that would best approximate the QC-RGBW reference data. A design matrix is created with the test values at the 68 test points. These values are fitted to the reference values and the fitting coefficients are derived by minimizing the differences between the observed value and the fitted value provided by the model.

Based on 68 pre-determined test points for this test panel, the correction matrix for the X, Y and Z for the RGB test station is

aX[1]=−0.014609; aY[1]=−0.017631; aZ[1]=0.024884;

aX[2]=0.931186; aY[2]=0.068468; aZ[2]=−0.003951;

aX[3]=−0.045284; aY[3]=0.817216; aZ[3]=0.004081;

aX[4]=−0.004684; aY[4]=−0.011521; aZ[4]=0.850434.

Different LCD panels would require similar characterization and Correction Matrix coefficients.

The correction matrix that was derived using the 68 test points was then tested on 14 random colors to verify that the RGBW test station data closely matches the RGBW reference station data. The X, Y values for the RGBW test station before and after correction, and for the RGBW reference station, are listed in Table 1, below.

TABLE 1

| COLOR | PR-920 x | CORR x | PR-655 x | PR-920y | CORR y | PR-655 y |
|---|---|---|---|---|---|---|
| White | 0.32352824 | 0.327974 | 0.329331 | 0.340375 | 0.341974 | 0.343765 |
| Fuchsia | 0.35224422 | 0.360816 | 0.363173 | 0.172005 | 0.180561 | 0.182261 |
| Red | 0.65313204 | 0.641612 | 0.642579 | 0.321278 | 0.335758 | 0.335626 |
| Silver | 0.32376869 | 0.328184 | 0.328522 | 0.339707 | 0.341261 | 0.341957 |
| Gray | 0.32113805 | 0.325412 | 0.325431 | 0.336726 | 0.338058 | 0.337165 |
| Olive | 0.41685473 | 0.418278 | 0.417847 | 0.491792 | 0.491392 | 0.491141 |
| Purple | 0.35257698 | 0.360775 | 0.361271 | 0.172896 | 0.180948 | 0.181612 |
| Maroon | 0.62940471 | 0.622069 | 0.62139 | 0.318817 | 0.329033 | 0.330627 |
| Aqua | 0.21512993 | 0.215182 | 0.214281 | 0.342231 | 0.340641 | 0.341281 |
| Lime | 0.28687607 | 0.282702 | 0.281148 | 0.604189 | 0.60588 | 0.604939 |
| Teal | 0.21291416 | 0.212729 | 0.21257 | 0.335306 | 0.33327 | 0.331828 |
| Green | 0.2812125 | 0.276707 | 0.276378 | 0.590598 | 0.591207 | 0.59239 |
| Blue | 0.13999057 | 0.144806 | 0.14401 | 0.065407 | 0.062932 | 0.062337 |
| Navy | 0.14435936 | 0.148637 | 0.149384 | 0.067779 | 0.064706 | 0.065681 |

FIG. 7B illustrates a chart 700B of variability amplitudes in a method for cloud computing in a test environment, according to some embodiments. Specifically, FIG. 7B illustrates variability amplitudes for the Y-coordinate in the tristimulus representation of a color chart. Accordingly, FIG. 7B illustrates an uncorrected Y-test data set 755B, a reference Y-data set 756B, and a corrected Y data set 754B.

The following error table shows the difference between RGBW test station data and RGBW reference station data. X and Y values before and after correction are listed in Table 2. Below table list the numbers of the corrections before and after.

TABLE 2

| | ORIGINAL | ORIGINAL | CORRECTED | CORRECTED |
|---|---|---|---|---|
| COLOR | ERROR x | ERROR y | ERROR x | ERROR y |
| White | 0.005803118 | 0.003390245 | 0.001357612 | 0.001791935 |
| Fuchsia | 0.010929051 | 0.010255611 | 0.002357682 | 0.001699973 |
| Red | −0.010552573 | 0.014348118 | 0.00096754 | −0.000131641 |
| Silver | 0.004753463 | 0.002249964 | 0.000338233 | 0.000696155 |
| Gray | 0.004292981 | 0.000438794 | 1.94125E−05 | −0.000893157 |
| Olive | 0.000992562 | −0.00065155 | −0.000431134 | −0.000251556 |
| Purple | 0.008693544 | 0.008715242 | 0.000495887 | 0.000663561 |
| Maroon | −0.008015031 | 0.011809138 | −0.000679522 | 0.001593174 |
| Aqua | −0.000848702 | −0.00094957 | −0.000900931 | 0.00064071 |
| Lime | −0.005728015 | 0.000750034 | −0.001553989 | −0.000941518 |
| Teal | −0.000344654 | −0.00347737 | −0.000159383 | −0.001441836 |
| Green | −0.004834236 | 0.001791446 | −0.000329158 | 0.001183251 |
| Blue | 0.00401903 | −0.003069638 | −0.000796601 | −0.000594766 |
| Navy | 0.005024664 | −0.002098077 | 0.000747138 | 0.000974822 |

FIGS. 8A and 8B illustrate random color comparison of the original error before and after the correction, as listed in Table 2.

FIG. 8A illustrates a chart 800A of variability amplitudes in a method for cloud computing in a test environment, according to some embodiments. Chart 800A illustrates the coordinate variability before an error correction algorithm is applied (e.g., RGBW correction algorithm). Curve 821A in chart 800A corresponds to column 1 in Table 2 above (counting columns from left to right). Curve 822A corresponds to column 2 in Table 2 above.

FIG. 8B illustrates a chart 800B of variability amplitudes in a method for cloud computing in a test environment, according to some embodiments. Chart 800B illustrates the coordinate variability after an error correction algorithm is applied (e.g., RGBW correction algorithm). Curve 821B in chart 800B corresponds to column 3 in Table 2 above. And curve 822B corresponds to column 4 in Table 2 above.

The mean and standard deviation of the error before and after correction are

TABLE 3

| | x AVERAGE | y AVERAGE | x STD DEV | y STD DEV |
|---|---|---|---|---|
| Before | 0.001013229 | 0.003107314 | 0.006387198 | 0.005811428 |
| Correction | | | | |
| After | 0.000102342 | 0.000356365 | 0.001028542 | 0.001064983 |
| Correction | | | | |

Tables 1, 2, and 3, and FIGS. 7A-7B, and 8A-8B show that the mean error has reduced by a factor of about 10 for the x value and by a factor of about 8.7 for the y value. The standard deviation can be reduced by a factor of about 5. Thus, variability values may be close to the mean value and a reference value, after correction. The RGBW correction matrix algorithm brings test values closer to reference values, thus mitigating the inter-station variability in a manufacturing environment.

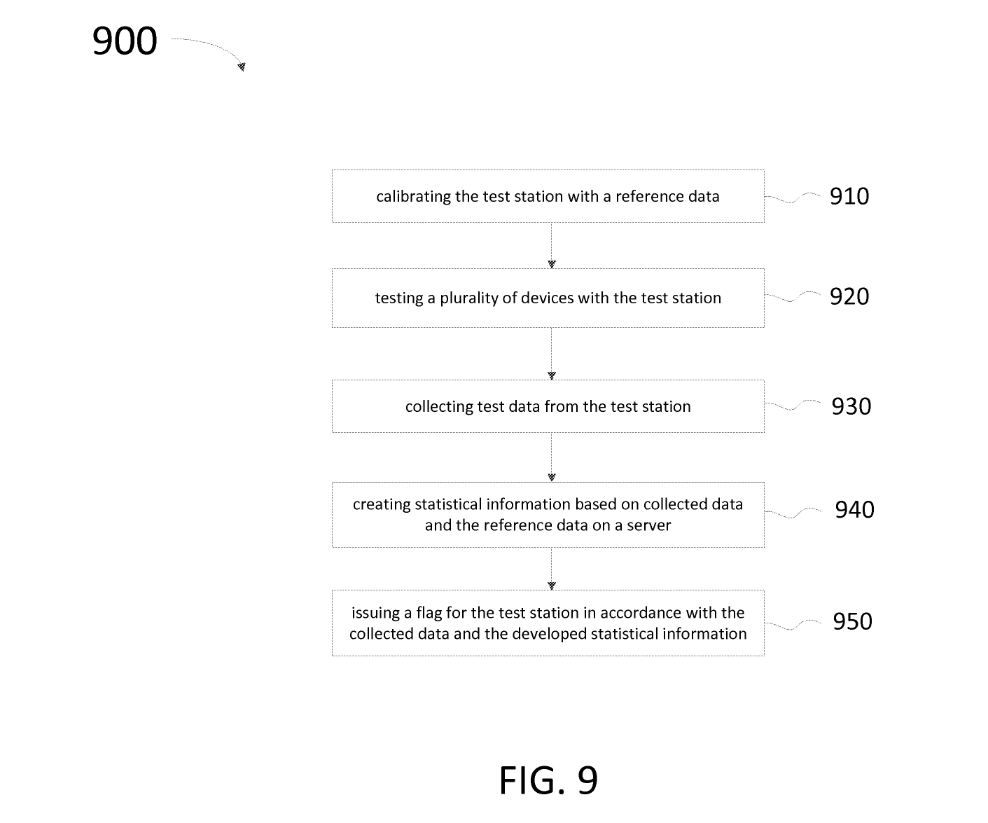

FIG. 9 illustrates a flow chart in a method 900 for collecting data from a test station to mitigate instrument variability in a manufacturing environment, according to some embodiments. Steps in method 900 may be performed partially or in full by any one of a plurality of servers in a system for cloud computing in a test environment (e.g., servers 110, 120, and 130 in system 100, cf. FIG. 1). Some embodiments may include a system such as system 400 performing method 900 (cf. FIG. 4). For example, a test station in method 900 may include a measuring test station and a reference test station (e.g., RGBW test stations 450 and QC-RGBW station 460, cf. FIG. 4). Accordingly, method 900 may include steps performed by a test station (e.g., test station 150, cf. FIG. 1, and RGBW station 450, cf. FIG. 4) and steps performed by a reference test station (e.g., reference stations 250-R, 252-R, and 252-R, cf. FIG. 2B, and QC-RGBW station 460, cf. FIG. 4).

Step 910 includes calibrating the test station with a reference data. Accordingly, step 910 may be performed when data collection server 130 determines that a performance characteristic variability of the test station is beyond a tolerance value. In some embodiments, step 910 may include collecting calibration data from a reference station, such as reference stations 250-R, 251-R, or 252-R (cf. FIG. 2B).

Step 920 includes testing a plurality of devices with the test station. Step 930 includes collecting test data from test stations. Accordingly, step 930 may be performed by data collection server 130 collecting data from a plurality of test stations. For example, the plurality of test stations may be as test stations 250 (cf. FIG. 2B). Or the plurality of test stations may be as test stations 251, or test stations 251 (cf. FIG. 2B).

Step 940 includes creating statistical information based on the collected data and the reference data on a server. In some embodiments, step 940 may include forming input-output charts using the collected test data and the collected reference data. In some embodiments step 940 may include forming input-output charts (e.g., charts 300A-300B, cf. FIGS. 3A-3E). According to some embodiments, step 940 may include determining performance characteristic variability (e.g., sensitivity variability 310, zero offset variability 330, nonlinearity variability 340, hysteresis variability 350, and random noise variability 360). Further according to some embodiments, step 940 may include forming variability amplitude charts and tables, including a maximum variability value and a root-mean-square variability value (e.g., chart 600, cf. FIG. 6). In some embodiments, step 940 may include forming variability amplitude before and after a data correction procedure (e.g., charts 700A-700B, cf. FIGS. 7A-7B, and charts 800A-800B, cf. FIGS. 8A-8B).

Step 950 includes issuing a flag for the test station in accordance with collected data and developed statistical information. For example, when the collected data departs from the reference data by more than a tolerance value, a flag is issued in step 940. In some embodiments, step 950 includes scheduling a calibration procedure for the flagged test station. In some embodiments, step 950 may further include forming a data correction algorithm for the test station. The data correction algorithm may include the statistical information, the collected data, and the reference data (e.g., color correction matrix as described above).

Accordingly, methods and systems as disclosed herein mitigate inter-station variability in an electronic display manufacturing environment. A color correction matrix method for testing electronic displays is disclosed as an exemplary embodiment. However, methods and systems as disclosed herein may be applied in different manufacturing environments, as one of ordinary skill in the art may recognize.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A system for cloud computing to mitigate instrument variability in a test environment, the system comprising:
a test station comprising a controller, a processing circuit, and a memory circuit, the test station configured to receive and test a device under test (DUT);
a station server configured to provide a data correction algorithm to the memory circuit in the test station; and
a data collection server configured to receive test data associated to the DUT in the test station, the data collection server further configured to provide a data correction algorithm for the test station to the station server.

2. The system of claim 1 further comprising an assembly line server configured to determine that the DUT is in the appropriate test station.

3. The system of claim 1 wherein the data collection server is configured to receive a reference data to provide the data correction algorithm.

4. The system of claim 1 wherein the data collection server comprises a load balancer circuit to receive a test data from a plurality of test stations.

5. The system of claim 1 wherein the data collection server is configured to schedule a calibration procedure of the test station.

6. The system of claim 1 wherein the station server is configured to install software in the controller of the test station.

7. A method for cloud computing to mitigate instrument variability in a test environment, the method comprising:
comparing a test time stamp with a reference clock;
issuing a station flag based on a calibration schedule;
receiving a test data from a test station;
determining a variability in the test data; and
correlating the test data with a reference data.

8. The method of claim 7 wherein issuing the station flag based on a calibration schedule comprises determining whether the test station is past a calibration date without a calibration.

9. The method of claim 7 further comprising comparing the variability of the test data with a tolerance value, and when the variability is larger than the tolerance value scheduling a calibration procedure for the test station.

10. The method of claim 7 wherein receiving a test data from a test station comprises receiving the test data from a plurality of test stations; and
determining a variability in the test data comprises performing a statistical analysis on the test data collected from the plurality of test stations.

11. The method of claim 7 wherein receiving a test data from a test station comprises receiving a plurality of test data sets from the test station, wherein the plurality of test data sets is originated from a plurality of devices under test (DUTs) in the test station.

12. The method of claim 7 further comprising forming a data correction algorithm for the test station based on the determined variability in the test data.

13. The method of claim 7 wherein correlating the test data with a reference data comprises collecting the reference data from a reference station.

14. The method of claim 7 wherein determining a variability in the test data comprises finding at least one of the group consisting of a sensitivity variability, a zero offset variability, a hysteresis variability, a nonlinearity variability, and a random noise variability.

15. A method for collecting data from a test station to mitigate instrument variability in a manufacturing environment, the method comprising:
calibrating the test station with a reference data;
testing a plurality of devices with the test station;
collecting test data from the test station;
creating a statistical information based on the collected data and the reference data on a server; and
issuing a flag for the test station in accordance with the collected data and developed statistical information.

16. The method of claim 15 further including forming a data correction algorithm for the test station based on the statistical information, the collected data, and the reference data.

17. The method of claim 16 further comprising providing a plurality of data correction algorithms to a plurality of test stations coupled to a station server, each one of the plurality of data correction algorithms associated to each one of the plurality of test stations coupled to the station server.

18. The method of claim 15 wherein calibrating the test station with a reference data comprises receiving the reference data from a reference station.

19. The method of claim 15 wherein creating a statistical information comprises finding a performance characteristic variability.

20. The method of claim 19 wherein finding a performance characteristic variability comprises finding at least one of the group consisting of a sensitivity variability, a zero offset variability, a hysteresis variability, a nonlinearity variability, and a random noise variability.
